(19) United States
(12) Patent Application Publication
(10) Pub. No.: US 2016/0127310 A1
(43) Pub. Date: May 5, 2016

(54) DISTRIBUTED INDUSTRIAL CONTROL MONITORING AND MANAGEMENT

(71) Applicant: CTEK INC., San Pedro, CA (US)

(72) Inventors: Michael James Sutter, Town of York, NY (US); Phillip Robert Sutter, Rancho Palos Verdes, CA (US); Angelo Meneses Lopez, Long Beach, CA (US)

(73) Assignee: CTEK INC., San Pedro, CA (US)

(21) Appl. No.: 14/932,919

(22) Filed: Nov. 4, 2015

Related U.S. Application Data
(60) Provisional application No. 62/075,178, filed on Nov. 4, 2014.

(51) Int. Cl. H04L 29/12; H04L 12/26; H04W 84/18; H04L 29/08

(52) U.S. Cl. CPC H04L 61/2069; H04L 61/3025; H04L 61/203; H04L 67/18; H04L 43/045; H04L 67/12; H04L 67/02; H04W 84/18

(57) ABSTRACT

An industrial control system provides for a bottom-up configuration and incremental growth in size and complexity without requiring system-specific programming at a central control or display point. XML packets are transmitted from the controllers upon event occurrences and controllers are assigned human meaningful names and group names. By knowing the addressing information for a single controller in a named group of controllers, the identity, addressing and basic status for other members of the group are provided graphically. This can allow operation in a low-bandwidth environment, including LTE cellular communications.

### RELATED APPLICATION

This non-provisional application claims the benefit under 35 USC 119(e) of provisional application 62/075,178 filed Nov. 4, 2014 by the same inventors. That application is hereby incorporated in its entirety herein.

### FIELD

This relates to addressing and managing a group of intelligent industrial controllers.

### BACKGROUND

There are at least two architectures used for creating a distributed industrial control system. One is top-down with a central control station that is programmed specifically to implement one or more control systems where the system logic is primarily in the central controller. The remote sensors and actuators are effectively sensed and controlled from the center controller. Traditional SCADA systems are an example of this architecture.

An alternate approach is a bottom-up architecture with remote intelligent controllers, each programmed with the logic for a portion of a control system. In this type of architecture any central system would be primarily responsible for monitoring the intelligent controllers at a high level rather than implementing the actual control logic step-by-step. In practice many systems are a hybrid of these two approaches.

Each of these architectures has advantages and disadvantages. They have different issues of security and may also have different bandwidth requirements. In a top-down system, the central controller can require very complex software that can be difficult to implement in an incremental manner as a system grows.

In a bottom-up system that issue would not be significant. Instead, a weakness of a distributed system may be the difficulty in seeing the big picture of the whole system. There are many diverse, autonomous, intelligent controllers, operating relatively independently. Some issues are compounded when the connections to remote controllers include one or more radio links with limited bandwidth.

### SUMMARY

Problems related to easily addressing and viewing the status of multiple intelligent controllers in a secure manner are addressed by a registry server that can be updated from a set of intelligent controllers. Many controllers can supply group identification information and overview status information to a common registry server. The updates can be triggered when status information changes. The intelligent controllers can find the registration server on a network by having addressing for that server stored internally in non-volatile memory. In conjunction with the registration server, a second server with access to the data of the registry server can provide access to the status of a named group of controllers to a client who only knows the addressing of any single member of the group. With this technology a set, or group of industrial endpoint controllers is collectively given improved addressability and manageability.

### BRIEF DESCRIPTION OF THE FIGURES

FIG. 1A is a schematic representation of a complete system showing initialization steps;

FIG. 1B is a schematic representation of a complete system showing client access steps;

FIG. 2 is a view of the system of FIG. 1A showing configuration tables;

FIG. 3 is a block diagram of an example intelligent industrial controller;

FIG. 4 is a flowchart of a controller unit first registering with a registry server;

FIG. 5 is a flowchart of steps by registry server;

FIG. 6 is a very simplified flowchart of the operational mode of an example controller;

FIG. 7 is a flowchart of a controller validating and redirecting a client;

FIG. 8 is a flowchart of the actions of an Access Server accepting a redirection of a client from a controller;

FIG. 9 shows a map with four controllers;

FIG. 10 is a flowchart of the actions of an Access Server sending a map to a client;

FIG. 11 is a flowchart of the actions of an Access Server handling controller getting group information;

FIG. 12 is a flowchart representation of steps a client can take in viewing system status.

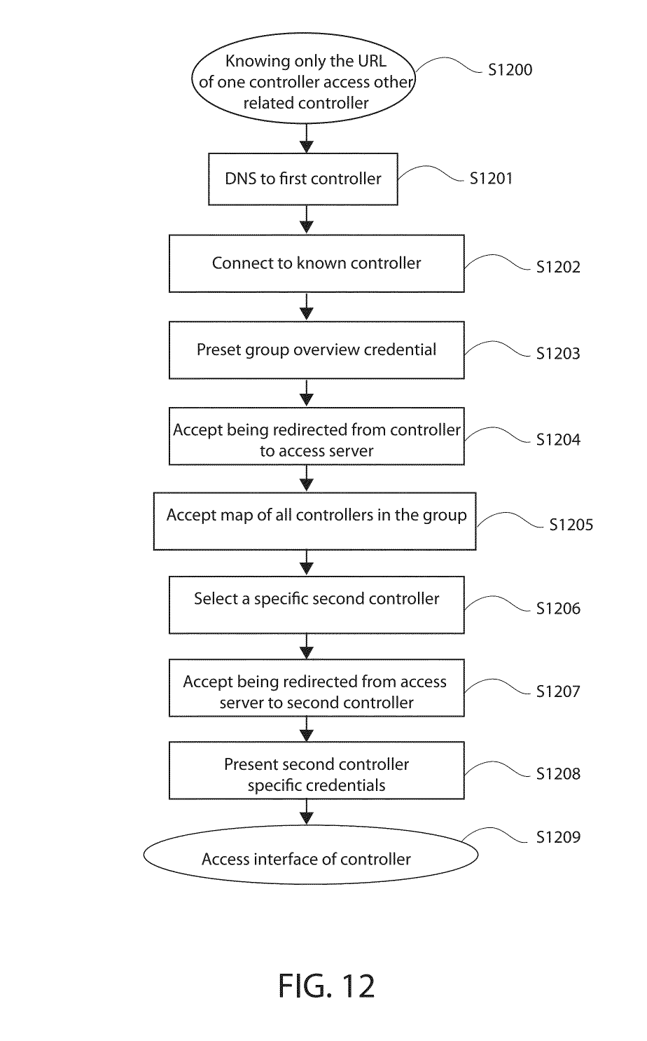

### DETAILED DESCRIPTION

While the principles of this technology can be applied in different ways with specific details suited to the specific problem at hand, it is best illustrated by explaining particular embodiments in some detail.

### First Embodiment

This system's architecture was driven by the need to readily monitor many industrial controllers and to also manage the control system on a by-exception basis without requiring special, per system, central programming. A bottom-up control system may evolve from a single controller to a large set of geographically disbursed controllers communicating in low bandwidth modes. The controllers can be readily monitored from a standard browser.

Controllers can be assigned to membership in a named group without regard to their location or network connection type. And, while preserving each of the controllers' respective security measures, all members of a common group can be readily monitored and addressed from a standard browser by a user who only knows the Internet address of any one of the controllers in the group. The overview information of basic status, geographical location, and the names of all other controllers in the group can be then be viewed via the browser.

### Structure of System Components

The primary components of the system are a registry server, an access server and several remote microprocessor-based industrial controllers.

Controllers

In the first embodiment, system multiple independent autonomous industrial control units are connected to the Internet in any arbitrary manner, including by radio transmission links using radio communication hardware and software. The control units have the following information stored internally in a non-volatile manner: URL or IP address of a trusted registry server, a group name, the controller name, the controller serial number, and URL or IP address of a trusted access server. These industrial controllers usually have location detection ability via GPS. In many practical embodiments a controller includes an autonomous control program executing on a microprocessor, interfaces to sense a physical state, and interfaces to control a physical result. Update information is sent to the registry server upon a change in status of a degree specified in the control program. This is done in a push manner. Typically, an industrial controller will have both monitoring and controlling elements.

Within each controller there is one web interface portion with credential verification for allowing access to the controller itself and there is a second web interface portion with credential verification for allowing access to learn the status, and the address of other group members. In this embodiment that is accomplished by transmitting an XML HTTP packet. When a controller verifies that a client computer has privilege to access all other members of the group, the controller redirects the session to the trusted access server, providing credentials to the access server to “vouch” for the client.

Registration Server

This server runs on a computer connected to the Internet. Its URL or IP address is stored in the controllers. It receives update XML data packets from controllers and adds to, or updates, a table in the database. The XML data format includes the controller's name, serial number, URL, lat. and long.; overall status bits, optional status information, and credentials to establish that the data is from an authorized controller. Another function of the registry server is to provide data to a controller whose programmed logic requires communications with other members in its group. Any packets that set or modify the controllers' reported URL/IP DNS information are sent by the registry server to a DNS server.

Access Server

This component is a web-interfaced server that reads controller information contained in the database in regard to a named group of controllers. It provides that data in a geographical map format to an HTTP client computer that has passed an authorization test. The access server does not necessarily have user credential checking itself. Rather, the access server accepts redirection of client sessions from an authorized controller and then allows that client to view the graphic display of information from the registry database for controllers that are members of the same group as the redirecting controller. All group members may be displayed. Alternatively, a hierarchy of credentials and filters might be used to display only certain member and/or certain status.

The display shows members of the group in relative geographical position to each other on a map, displayed with their name and status information from the registry. By selecting a particular second controller on the map a user can be redirected from the access server to that second controller's web interface.

That redirection does not imply any authorization to access the second controller's internal state beyond the basic information already visible. Each controller protects itself, possibly in a controller-specific manner, before allowing access to more layers of information and control. Once passing sufficient authorization, a client can read deeper information and can change a controller's configuration, including the group that the controller belongs to and the control program it runs.

Database

The Database can be a simple table if the access server and the registry server are tightly coupled or it can be any other data storage that can be read and written by the registry server and read by the access server. In some embodiments it is a database indexed by controller serial number.

### Operation of Overall System

This system provides user access to collections of industrial controllers at two fundamental levels of authorization via servers that do not require programming dependent upon the specific controllers, their programming, or tasks. One level of access is simply read-only privilege to information about the name, Internet address information, physical location, and general status of all controllers belonging to a named group. The second level is access to a direct connection to the internals of a specific controller in the group.

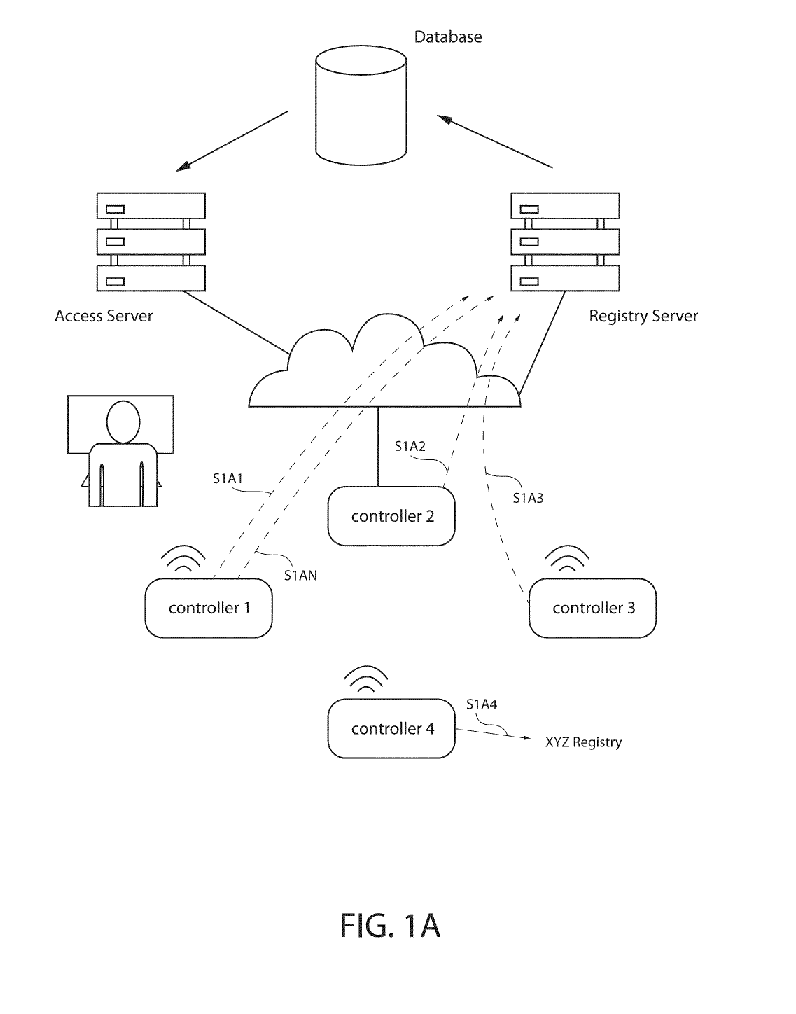

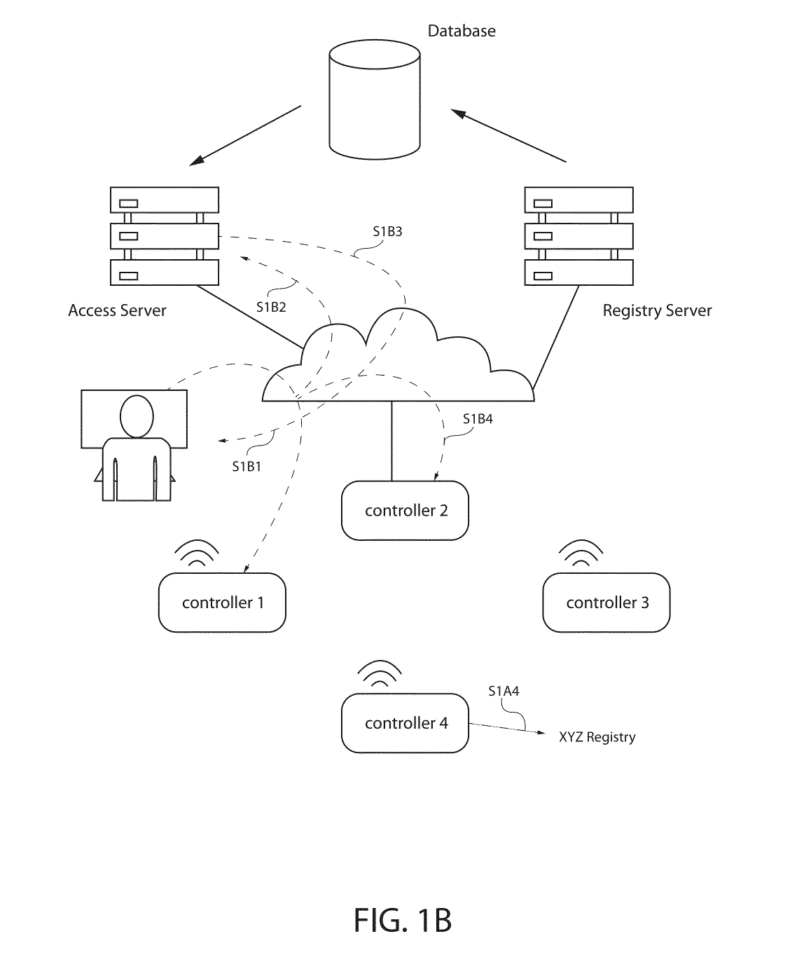

At initialization the registry database may have no stored information. As each controller comes online it transmits (S1A1, S1A2, S1A3, S1A4) an XML packet to its designated registry server. The packet contains its serial number, group name, the controllers unique Fully Qualified Domain Name (FQDN), its IP address, and current geographical location as shown schematically in FIG. 1A. The access server stores this information in the database. It also communicates the controller's FQDN and IP address to a DNS server. This is repeated when a controller determines an event worth reporting occurs (S1AN). Notice that in FIG. 1A, three of the four controllers are represented as communicating with the rest of the world over radio-based connections and one is shown as wire-connected.

At any time after initialization, a user at a client computer may desire to see the status of all controllers belonging to a named group of controllers. One way to get that access is by knowing the FQDN of a single controller and to have the group overview credentials. As described above, the client connects over the Internet (S1B1) to the particular controller whose addressing it knows. This is shown schematically in FIG. 1B. Then the client presents group overview level credentials to that controller. After verifying those credentials, the controller redirects (S1B2) the client session to the access server along with its own controller credentials, allowing that server to trust and accept the redirection.

Now that the client computer has a direct packet-based connection to the access server, the client can see basic overview information about members of the group, That is accomplished by the access server's web interface presenting a map image with icons and text updated as data is submitted by the various controllers in that group (S1B3). It can be a dynamic display, representing new data received from controllers by the registry server.

Example of records in four controllers, two are in a common group.

Controller 1

| | |
|---|---|
| Trusted Registry Server | update_ABC.com |
| Trusted Access Server | access_ABC.com |
| Serial # | 1234 |
| Group Name | “Irrigation” |
| Controller Name | “Pump” |
| Controller URL | pump_1234.bottomup.com |
| Controller IP Address | 173.58.240.169 |
| Basic Status | “A” |

Controller 2

| | |
|---|---|
| Trusted Registry Server | update_ABC.com |
| Trusted Access Server | access_ABC.com |
| Serial # | 5678 |
| Group Name | “Irrigation” |
| Controller Name | “Rainfall Monitor” |
| Controller URL | Rainfall_monitor_5678@bottomup.com |
| Controller IP Address | 92.242.140.21 |
| Basic Status | “A” |

Controller 3

| | |
|---|---|
| Trusted Registry Server | update_ABC.com |
| Trusted Access Server | access_ABC.com |
| Serial # | 9876 |
| Group Name | “Jones Farm” |
| Controller Name | “Tractor #1” |

Controller 4

| | |
|---|---|
| Trusted Registry Server | update_XYZ.com |
| Trusted Access Server | access_XYZ.com |
| Serial # | 2468 |
| Group Name | “Irrigation” |
| Controller Name | “Soil Moisture” |

While controllers 1, 2 and 4 all are set with a group name of “irrigation”, only the data from 1 and 2 are reflected in the registry update table below. While controller 4 does have irrigation as its group entry, it is in an entirely different naming domain since its updates go to update_XYZ.com. Since controller 4's trusted registry server is not the same logical server as the other three (update_ABC.com) it has a completely distinct name-space for groups and for controller.

### Example Controller Hardware and Software Structure

The industrial controller hardware may include a watchdog timer, differential serial port, general purpose I/O, analog, pulse and digital inputs and outputs. An industrial controller is a self-contained device having a CPU, having its program storage in non-volatile memory. At reset or power up it automatically commences running programming implementing a control mechanism.

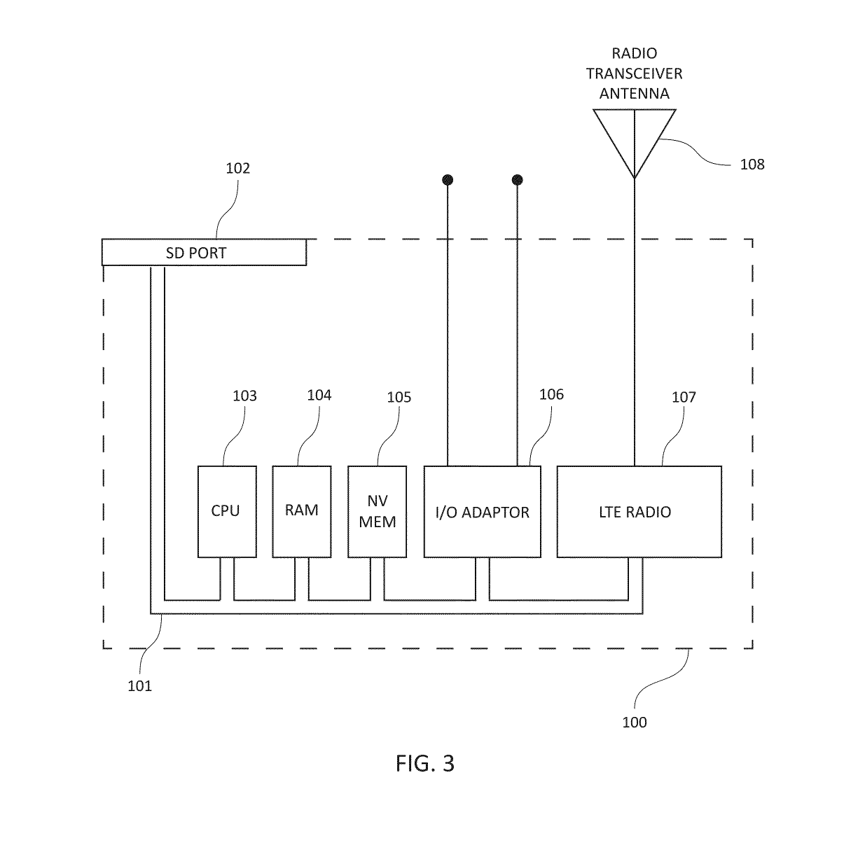

A feature of the example controller embodiment of FIG. 3 is an LTE radio and antenna. An LTE radio is included in many controllers since devices and systems are frequently widely disbursed in the field or deployed on moving vehicles making it more important to offer wireless connections. Due to their intended use, industrial controllers are typically designed and packaged to be rated for operation of an extended temperature range. One example, the SkyRouter, is rated to operate between −40 and +85 degrees F.

A suitable CPU is the ATMEL 9260 based on the ARM architecture; and Linux is a suitable operating system. The components of the example industrial controller of FIG. 3 include a CPU 103, a bus 101, non-volatile memory that holds the programming 105, RAM 104, an SD port for NV memory expansion 102, serial I/O 106, an LTE radio 107 with a connection for an antenna 108. It is a self-contained unit in one package 100.

### Power-on Initialization

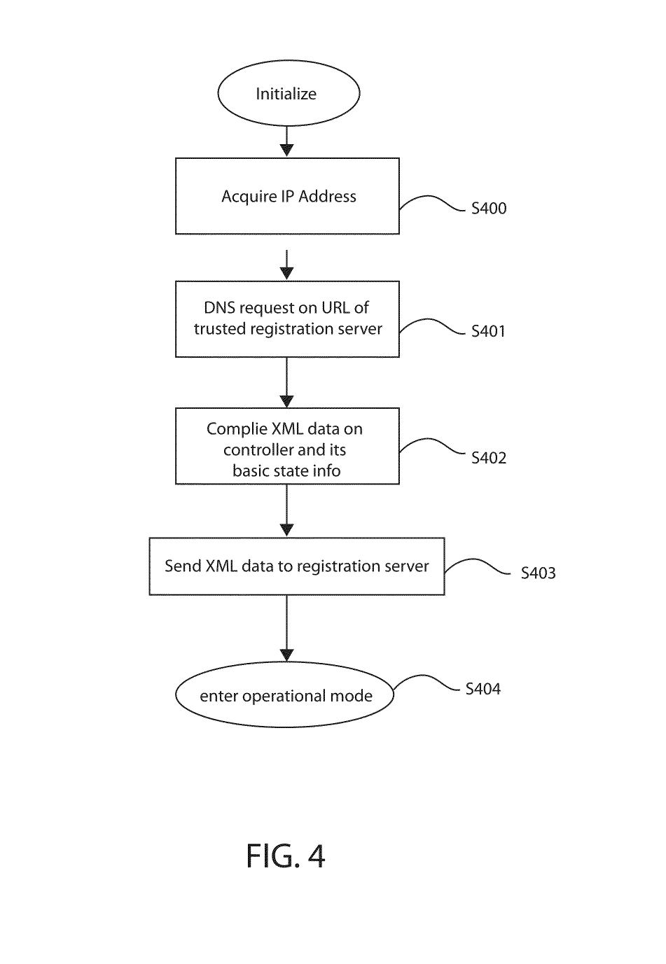

As mentioned above, each controller transmits information over the Internet to a trusted registry server. FIG. 4 illustrates the steps involved in this process.

When a controller is powered on or reset, it goes through an initialization process. If the controller does not have an assigned IP Address, it acquires one (S400). This might be by DHCP. It also performs a DNS request (S401) on a stored URL that points to the controller's pre-assigned trusted registry server. In the case of controller 1, that would be “update_ABC.com” The controller also gathers and puts information into a predetermined XML schema (S402). The data includes its serial number, name, group name, URL, IP address, a one-character basic status indication, and its latitude and longitude. In the case of controller 1, that would be 1234, “Pump”, “Irrigation”, pump_1234. bottomup.com, 173.58.240.169,A, 41.8369° N, 87.6847° W. After the XML data is compiled, it is sent to the IP Address of the trusted registry server by an HTTP PUT (S403). Other controller-specific initialization may be done and then the controller can enter an operational mode (S404). Controllers 2 and 3 also initialize and send their vital information to update_ABC.com. Controller 4, instead, sends its initialization data to update_XYZ.com.

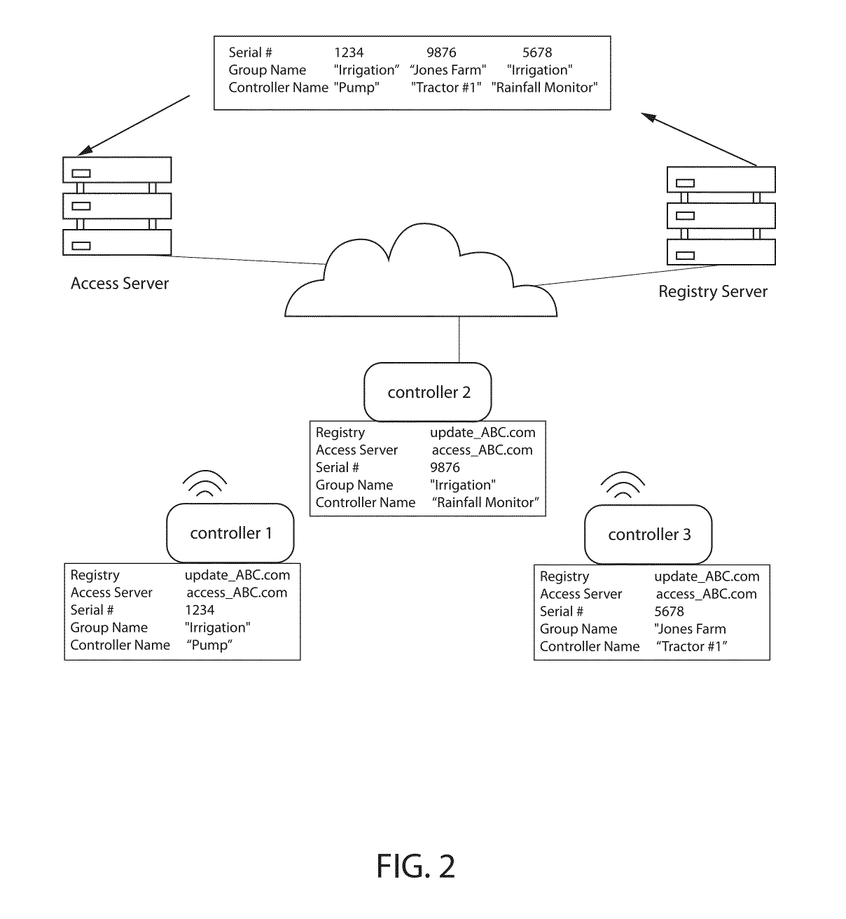

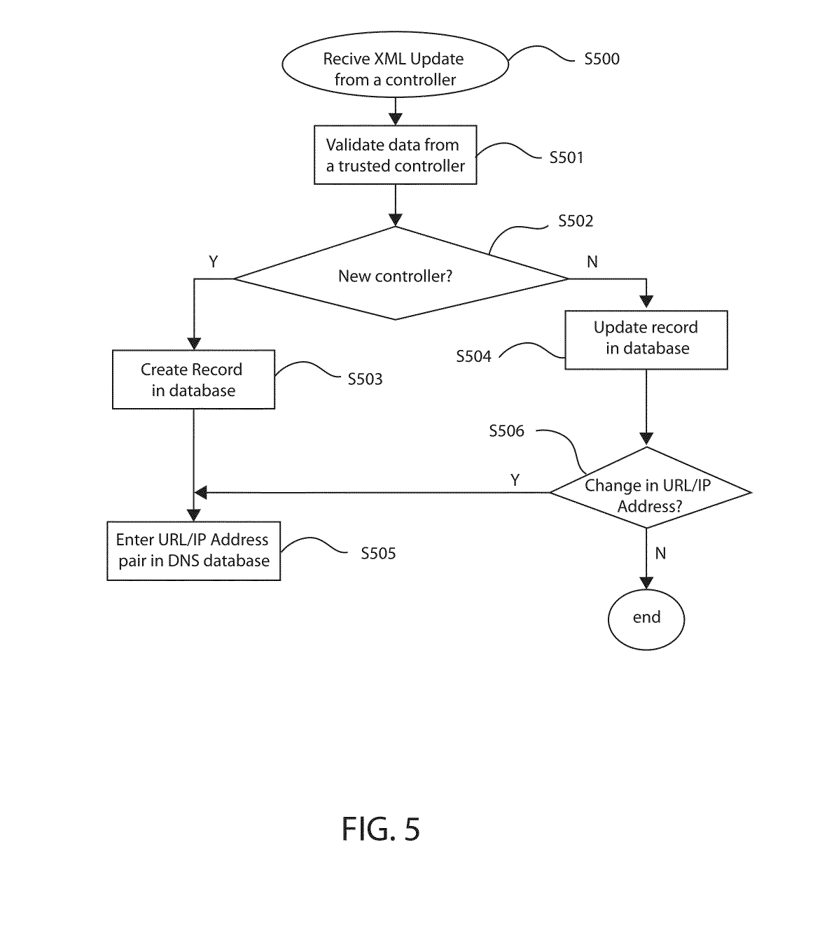

The registry server update_ABC.com that the data for controllers 1, 2, and 3 is sent to performs the steps shown in FIG. 5. It receives the XML data (S500) and may do checks on the data to confirm that the information is from a proper controller (S504). If this is the first time the registry has heard from a particular controller (S502), it creates a record in the database (S503) with the received data. If a record already exists in the database for the controller's serial number, that record is updated (S504). If it is a new record or is an update to a record having a modification in URL or IP address, the URL/IP Address is sent to a DNS server. FIG. 2 shows an overlay of the configuration data onto the system block diagram for the ABC controllers.

### Registry Update Table for Server ABC

Registry on update_{—} ABC.com after all controllers initialize.

| | | | |
|---|---|---|---|
| Serial # | 1234 | 9876 | 5678 |
| Group Name | “Irrigation” | “Jones Farm” | “Irrigation” |
| Controller Name | “Pump” | “Tractor #1” | “Rainfall Monitor” |
| Lat./Long | 34.0500° N, | 15dd7833° S | 33.7683° N, |
| | 118.2500° W | 47.8667° W | 118.1956° W |
| 4-state-status | Normal | Normal | Problem |
| status-label | ASCII | ASCII | ASCII |
| status-value | ASCII | ASCII | ASCII |

Registry on update_{—} XYZ.com after controllers initialize

| | |
|---|---|
| Serial # | 2468 |
| Group Name | “Irrigation” |
| Controller Name | “Soil Moisture” |
| Lat./Long | 34.0500° N, 118.2500° W |
| 4-state status | Normal |
| status-label | ASCII |
| status-value | ASCII |

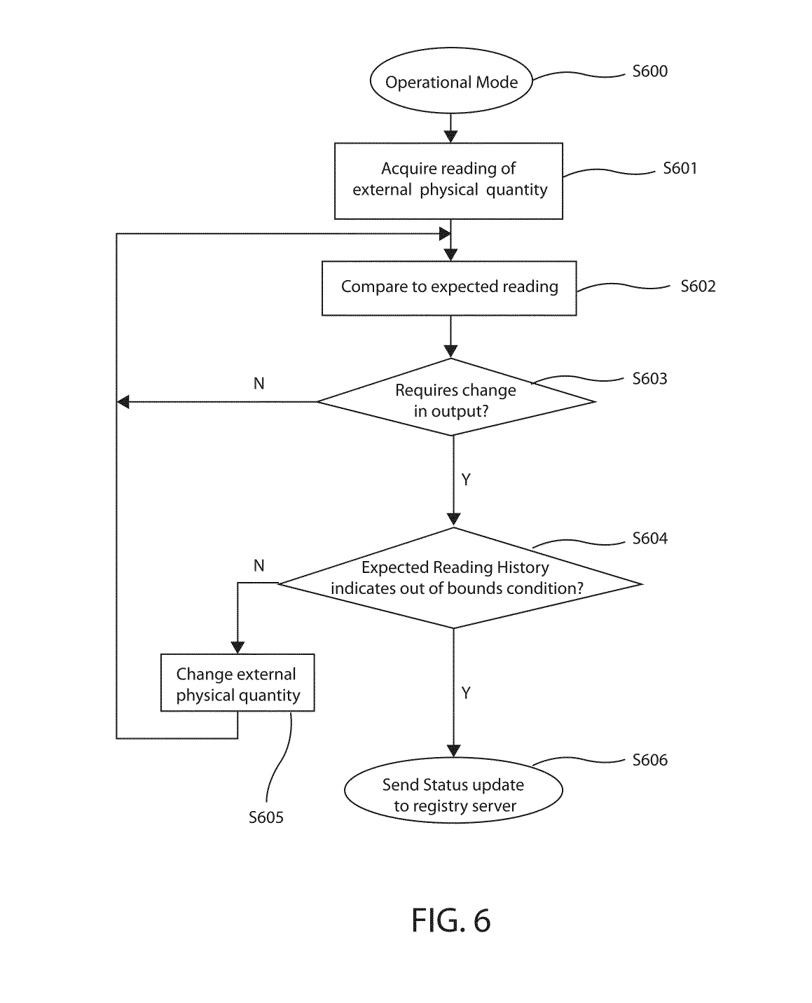

FIG. 6 shows a high level flowchart of a controller's operational mode. The actual task of a controller can vary widely, this is one simplified example. After entering operational mode (S600) the controller enters a loop of measuring an external quantity (S601), possibly the level of a tank of liquid. Using its internal, pre-programmed control algorithm, the controller determines (S603) if the history and state of the input requires a change in output. If so, the condition is checked to see if it is out-of-bounds (S604) of some pre-programmed criteria. If so, XML data is sent to the trusted server in a manner very similar to the actions that occur at initialization. The trusted server updates the corresponding record in the database.

### User Access

One feature of this embodiment is that a user at a browser running on an arbitrary client computer who only knows the URL or IP Address of a single controller can quickly get a picture of all of the controllers in the group, including their basic status. In another scenario, a user might have physical access to one controller and desire to see what all of the members of the group are doing. The direct physical access scenario is likely to occur during field installation or maintenance of a controller.

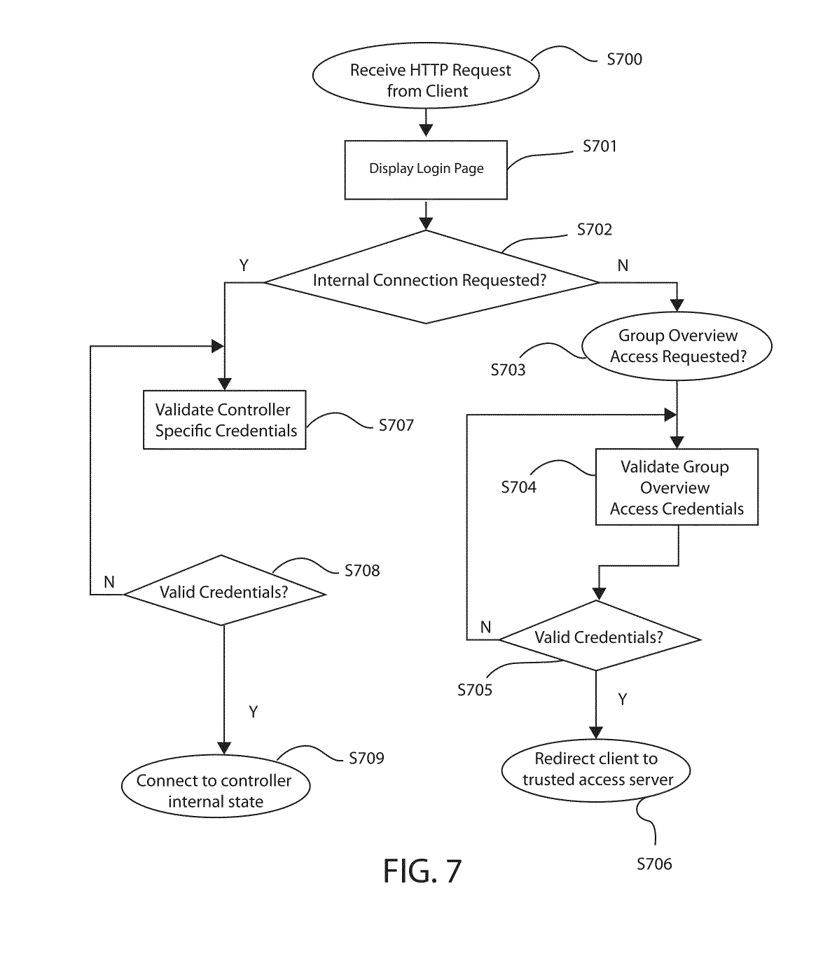

In any case, given its URL, the client computer connects to the single controller the user knows. This sequence is seen in the flowchart of FIG. 7 from the controllers' point of view. The controller receives the HTTP request (S700) and provides a login page to the user (S701). If the user is simply using the controller as a gateway to get to the access server (S703), the user provides (S704) and the controller validates the users credentials (S705) to see the identity and basic status (overview) of all members of its group. This doesn't provide the user any direct access to the operational functioning or configuration of the controller.

Accessing the operational mode functions or modifying controller configuration would require the user taking a different path through the login page as seen in FIG. 7. In that case an internal connection request would be received (S702). A controller-specific set of credentials would be received (S707) and validated (S708) before the client computer is connected to the controller's operational logic (S708).

Returning to look at the first branch at the step of validating group overview credentials (S705), after that validation, the controller redirects the session with the user to the trusted access server (S706). This is the mechanism by which a user who knows the addressing of a single controller gets to see the status of all other controllers in the initial controller's named group.

### Access Server

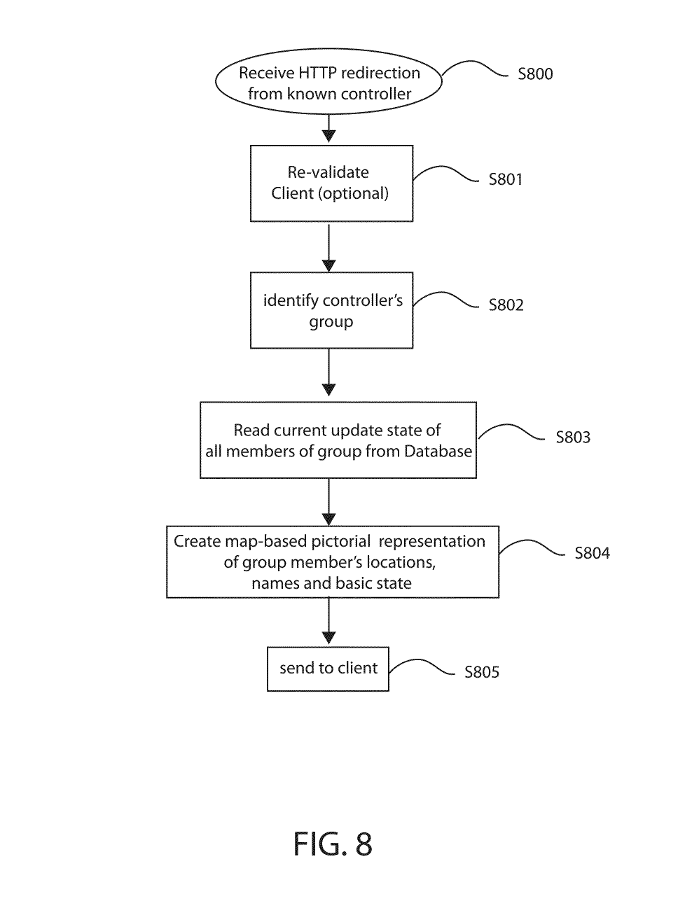

FIG. 8 shows the reaction this redirection causes in the access server. The access server receives, and acts upon, the redirection (S800) but only when it is from a known controller. Additional validation (S801) of the client could be performed. In some embodiments this is an architectural decision. In some embodiments an overall architectural decision dictates that controllers do all user password checking. One benefit is the sharing of access servers and update servers by multiple organizations without each organization having to deal with the shared system having passwords.

The purpose of the client giving the group overview credentials to the initial controller was to see the names and states of all of the members of the group. The next step of the access server is to identify the group that the redirecting controller belongs to (S802) and look up the records of all other group members (S803). That information the user desired could be sent to the user in a variety of forms. It could be plain text, XML, or graphical for example. In the embodiment of FIG. 8 it is presented graphically. The access server creates an HTML page with the group controllers shown in relative positions to each other corresponding to their actual geographic locations. It need not be to scale or to be a realistic map. The name and basic state of each controller is inserted into the map and the HTML page is sent to the client (S805). Other information, such as the IP addresses, might also be displayed. As states of the controllers change, the page can by dynamically update, possibly with animation, or could require a user initiated refresh.

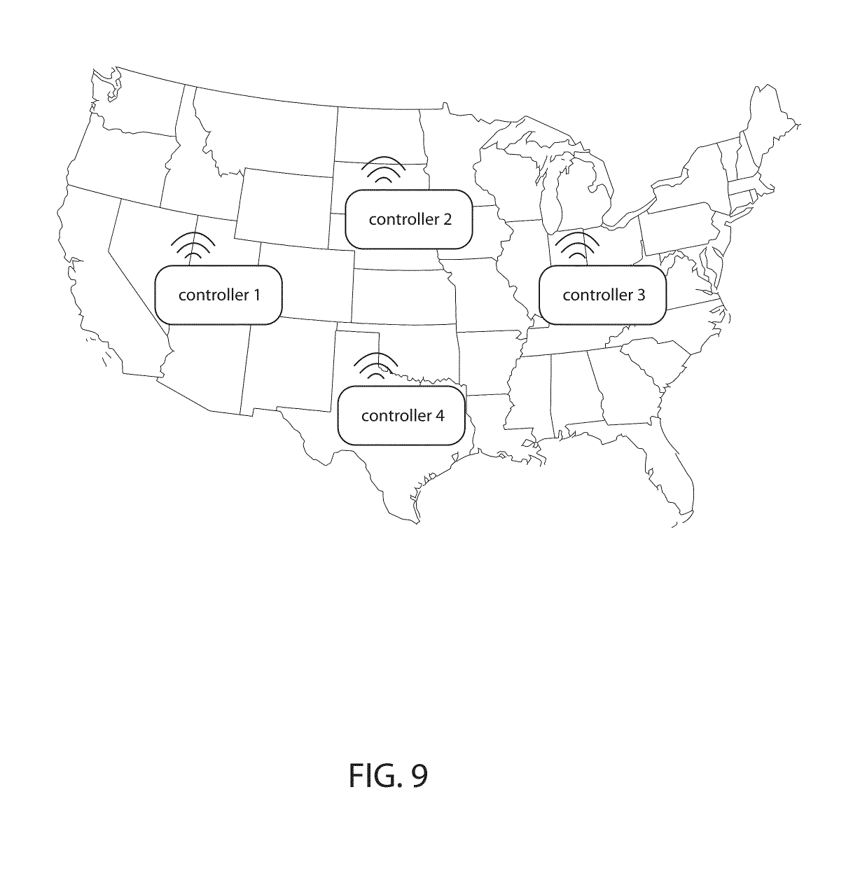

FIG. 9 shows an example of a group overview map created by the previous steps for controller 1, 2 and 3. Controller 4 belongs to a different group so it is not displayed, and controller 4 uses a different trusted registry server entirely. That server could be running on the same hardware as the first registry server or could even be an alias for the first registry server as long as separate name spaces were maintained.

At this point in a usage scenario, the user has an overview of the controller group. Presumably they are grouped because they have some commonalty of task or of ownership. The user reached this point by knowing the addressing information of a single controller but now has addressing knowledge of all of the controllers assuming the IP addresses or URLs of each controller were set to be displayed. To make addressing and accessing any of the controllers in the group even easier in some embodiments, the user can select a controller from the map display and be taken directly to that controller by a second redirection.

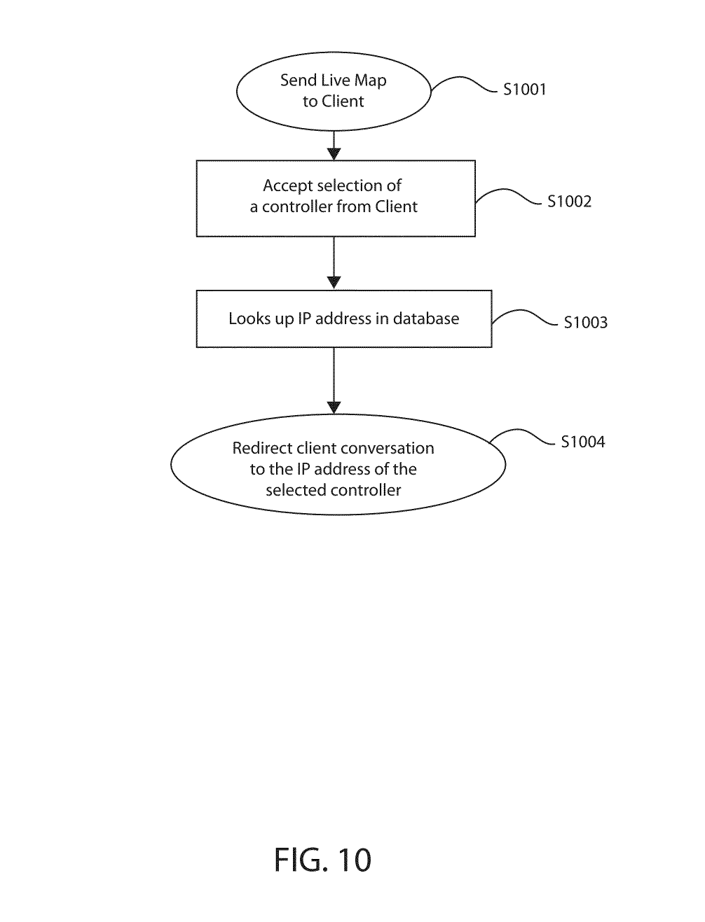

FIG. 10 is a flowchart showing the steps in that process. After the live map is sent to the client (S1001) the user may select a particular displayed controller in the group. The access server looks up the IP Address of that controller in the database (S1003) and then redirects the client session to that controller (S1004).

### Configuration

Configuration at Factory or by Distributor

The configurations information in each controller can be loaded at various stages and can often be changed on-the-fly. At the time of manufacturing, a serial number might be set. If the manufacturer or a distributor was preparing a batch of controllers for a specific customer, the trusted registry server and access server would likely be known at that point and could be set. Group IDs might also be set at the manufacturer or distributor if the customer had pre-planned the number of units to initially belong to each group.

Meaningful controller names like “Jones Farm Pumping Station” might have been completely worked out in advance and they could also be set. In most practical situations, if such specific settings were programmed into each controller, they would be labeled in a human-readable manner to facilitate the proper controller being deployed at its intended location. Separately, each controller has a control function that would be programmed into the respective controllers at some point in the supply chain.

Configuration in the Field

In some cases a system integrator or other user might set the names and local programming into a controller before delivering it to the field. Alternately, some controllers can be given their name, group ID and local control programming in the field as they are installed. In a bottom-up, incrementally growing system, this last option might be most appropriate.

Automatic Reconfiguration

With the possible exception of the serial number, the other fields might be programmed or re-programmed after installation. A utility program can use a menu-based approach, graphic interface or even a text interface to allow a user to see the current programming of a set of controllers and to indicate the desired changes. A utility program could then propagate those changes to the installed controllers over the Internet.

Variations

Peer-to-Peer

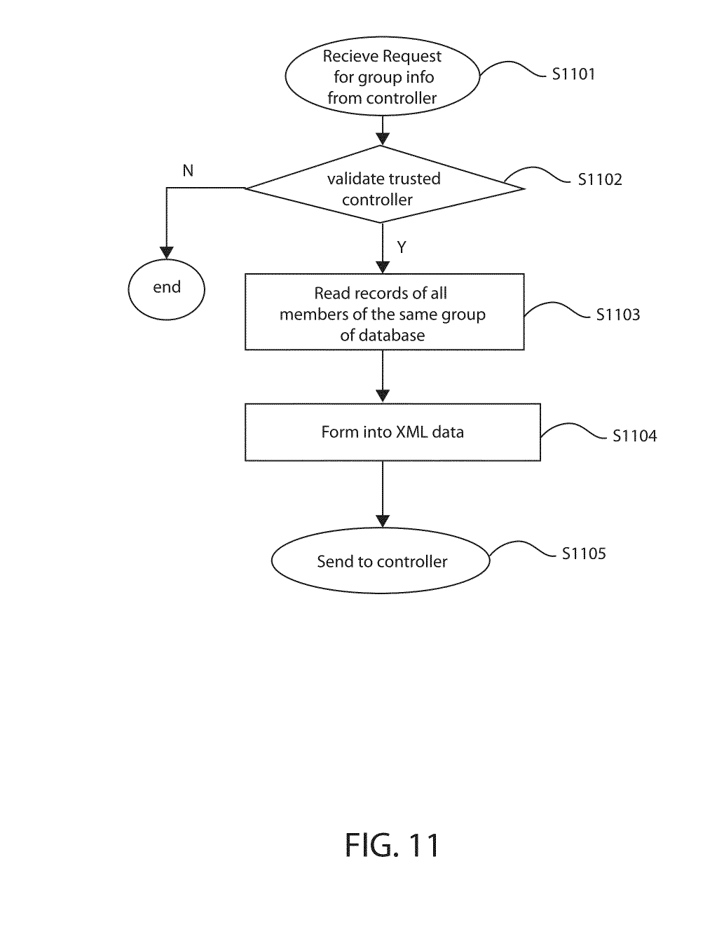

In some systems the controllers may have controller-to-controller interaction. One example would be the logic of controller A depending upon an input physically connected to controller B. To facilitate peer-to-peer operations, controllers need to know how to find each other. In the following embodiment, a controller need only know the name of a second controller it desires to communicate with. In summary, a controller requests the names and address of its fellow group members from the access server. FIG. 11 is a flowchart of operations performed by the access server to facilitate group self-knowledge. In the first step (S1101) the access server receives a request for group information from a controller. Validating (S1102) that the request is from a valid controller in the group may be important in practical embodiments. The access server gathers up the name, IP Address, and URL of each controller in the group (S1103), puts the information into an XML format (S1104), and sends the result back to the requesting controller (S1105).

With that information, a controller can use the IP Address or do a DNS request on the URL of a specific group member and then access that controller on a peer-to-peer basis.

Display

While a map is a very convenient way to visualize the names, groups and status of a set of controllers, the same information can be presented to a user in many formats, including text-based and menu based. It is also possible to have a machine-friendly interface and not require a human operator.

Privilege

Although the explanation above discusses only two types of credentials, a more complex hierarchal system could be useful in some systems. While the embodiment above explains that knowing one controller's address allows all controllers in its group to be known, in a variation, the overview privilege might only provide a view of some, but not necessarily all, members of the group.

Basic Status

The basic status mentioned above includes name information, Internet addressing information, lat./long., and one character of status. Other fields that can be present in system variations are the speed and heading of a controller that is associated with a vehicle. Status and monitored values could include a two-column presentation of multiple qualities with the name of the quantity in the left column and value in the right column for an arbitrary number of measured items. One flexible way to mechanize this is to have the controllers know the name of the quantity, and any conversion factors to “engineering values”. The controllers could send a text that goes into the database with everything else and gets displayed on the map without the access server having any knowledge of the actual data or units.

A controller management system, called SkyCloud, is an example of a control system consistent with this disclosure.

The embodiments of the invention are illustrated and described by way of example and not by way of limitation. The metes and bounds are set out in the claims below and as they may be amended.

It is claimed:

1. A method of operation of an industrial controller endpoint device having a CPU, memory, operating system and radio communication hardware comprising:
a) transmitting an HTTP page for credential verification, a response to which leads to at least two distinct credential requirements, where at least one of the credential requirements relates to privileges to modify the state of the endpoint device and at least a second credential requirement relates to transferring the HTTP session to a trusted server;
b) redirecting the HTTP session to the trusted server after verifying at least a second set of credentials locally within the endpoint device;
c) Indicating to the server, implicitly or explicitly, during the redirection that credentials for allowing the server to identify other members of a named group of endpoint devices have been verified.

2. The method of operation of an endpoint device of claim 1 further comprising transmitting the endpoint device's location and status information to the trusted server.

3. The method of operating the endpoint device of claim 1 further comprising:
transmitting data upon startup to a predetermined server, the data including at least a Fully Qualified Domain name and an IP address that represent the addressing information for the endpoint device, the data further including a unique identifier for the endpoint, an endpoint group name, and location information.

4. A method for determining the network address of a specific endpoint device that belongs to a set of endpoint devices having arbitrary addressing, the determining requiring only the network address of a single member of the endpoint set comprising:
a) transmitting an HTTP request to the single known member endpoint,
b) satisfying a credential verification exchange with the endpoint,
c) accepting a redirection from the endpoint to a server;
d) accepting geographical location information for other members of the set and providing that information to a user;
e) accepting, from a user, a selection of at least one other member of the set;
f) receiving address information for that other member of the set.

5. The method for determining the network address of claim 4 where the providing of geographical location information to the user is a graphical representation of the locations of other members of the set on a map.

6. The method for determining the network address of claim 5 where the graphical representation also includes a representation of status information from members of the set.

7. An apparatus for controlling a physical state monitored by the apparatus, comprising an industrial controller having a CPU, a non-volatile program store, memory, a radio-based interface; the apparatus packaged to operate over an extended temperature range; where the industrial controller is configured to perform the following in any operable order:
a) transmitting information regarding network addressing of the apparatus, location of the network apparatus and a group identification of the apparatus to a server over a network;
b) monitoring, autonomously, at least one physical quantity;
c) emitting a control signal to control at least one physical state related to the physical quantity based at least on part by the autonomous monitoring result;
d) transmitting information regarding the occurrence of a predetermined exception related to monitoring the at least one physical quantity, to a server over a network, the transmitting triggered by the exception occurrence and without requiring polling.

8. A method for addressing and managing remote intelligent industrial control devices comprising a computer system performing the following actions:
a) receiving data transmissions from a plurality of intelligent industrial control devices, the transmitted data comprising the devices' FQDN, IP address, group name and location information;
b) storing the received device data for future retrieval;
c) receiving a request from a client computer requesting location and status information of intelligent industrial control devices belonging to a named group of devices without the requirement of the client computer to provide network naming or addressing information other than the full group name, or optionally the network addressing, of one member of the group, where the network addressing can be arbitrary;
d) looking up the addressing or naming of other group members from the stored data;
e) transmitting to the client computer the stored device data of devices belonging to the named group.

9. The method of claim 8 where the received request includes a group name.

10. The method of claim 8 where the received request was a request originally initiated by the client computer to a member of the device group and subsequently redirected to the computer system, the computer system determining the name of the group by looking in the stored device data for the name of the group the redirecting device belongs to.

11. The method of claim 8 where the transmitting of the data from devices belonging to the named group to the client computer is an HTTP HTML response with the location information indicated graphically.

12. The method of claim 9 where the transmitting of the data from devices belonging to the named group to the client computer is an HTTP HTML response with the location information indicated graphically.

13. The method of claim 10 where the transmitting of the data from devices belonging to the named group to the client computer is an HTTP HTML response with the location information indicated graphically.

14. The method of claim 11 where the HTTP HTML response allows user selection of one or more filtering criteria providing for showing, hiding or optionally displaying in a different manner, the graphic indication of the location information.

15. The method of claim 9 further comprising the step of connecting the client computer to a specific device selected by a user graphically from a graphic display.
